(19) United States
(12) Patent Application Publication
(10) Pub. No.: US 2004/0174533 A1
(43) Pub. Date: Sep. 9, 2004

(54) Wavefront aberration measuring apparatus

(76) Inventor: Akihiro Nakauchi, Tochigi (JP)

Correspondence Address: MORGAN & FINNEGAN, L.L.P., 345 PARK AVENUE, NEW YORK, NY, 10154, US

(21) Appl. No.: 10/793,492

(22) Filed: Mar. 3, 2004

(30) Foreign Application Priority Data
Mar. 5, 2003 (JP) 2003-057971

(51) Int. Cl. G01B 9/02

(52) U.S. Cl. 356/515; 356/521

(57) ABSTRACT

An aberration measuring apparatus capable of measuring wavefront aberration at a high degree of accuracy regardless of the magnitude of aberration of an optical system is disclosed. This aberration measuring apparatus includes a first mask which generates a wavefront including wavefront aberration of the optical system and a reference wavefront not including wavefront aberration of the optical system with respect to a predetermined direction, a second mask which generates two wavefronts, both of which include wavefront aberration of the optical system and a detector placed at a position where the two wavefronts generated by the first mask or the two wavefronts generated by the second mask form an interference pattern. Wavefront aberration of the optical system is calculated based on the interference pattern detected by this detector. Then, the aberration measuring apparatus can switch between a mode for measuring wavefront aberration of the optical system using the first mask and a mode for measuring wavefront aberration of the optical system using the second mask.

### BACKGROUND OF THE INVENTION

1. Field of the Invention

The present invention generally relates to a wavefront aberration measuring apparatus, and more particularly, to a wavefront aberration measuring apparatus which measures wavefront aberration of an optical system used for soft X-rays.

2. Related Background Art

When manufacturing a micro semiconductor device such as a semiconductor memory or logical circuit using a photolithography (printing) technology, a reduced projection optical system is conventionally used which transfers a circuit pattern by projecting a circuit pattern drawn on a reticule or mask (these are used as mutually interchangeable terms in the present application) to a wafer, etc., to which a photosensitizer is applied, by a projection optical system.

A minimum size (resolution) that can be transferred using a reduced projection photolithography apparatus is proportional to the wavelength of light used for exposure and inversely proportional to a numerical aperture (NA) of the projection optical system. Therefore, the resolution increases as the wavelength is shortened. For this reason, in response to a growing demand for miniaturization of semiconductor devices in recent years, light of shorter and shorter wavelengths is used for exposure and light sources capable of supplying UV rays of shorter wavelengths such as an ultra-high pressure mercury lamp (i-line) (wavelength: approximately 365 nm), KrF excimer laser (wavelength: approximately 248 nm) and ArF excimer laser (wavelength: approximately 193 nm) are used.

However, miniaturization of semiconductor devices is advancing at an accelerating pace and there is a limitation to lithography using UV light. Therefore, to transfer an extremely small circuit pattern of 0.1 μm or less in size, a reduced projection optical system using soft X-rays (EUV light: extreme ultraviolet light) having a wavelength of approximately 5 nm to 15 nm, which is a much shorter wavelength than that of UV light, is under development.

In the wavelength range of EUV light, light absorption by a substance increases considerably, and therefore a refractive optical system using refraction of light used with visible light or UV light is not practical and a reflective optical system using reflection of light is used for a photolithography apparatus using EUV light.

As a reflective optical device making up a photolithography apparatus using EUV light, a multilayer film mirror with two types of substances with different optical constants alternately laminated one atop another is used. For example, several tens of layers of molybdenum (Mo) layer and silicon (Si) layer are alternately laminated on the surface of a precisely polished glass substrate.

In the initial stage of assembly and adjustment of a projection optical system, the projection optical system generally has large aberration. For this reason, wavefront aberration of the projection optical system is measured and based on such a wavefront aberration value, optical members of the projection optical system are adjusted and the aberration performance of the projection optical system is improved.

As the method of measuring wavefront aberration of a projection optical system used for EUV light, a Point Diffraction Interferometer (hereinafter referred to as “PDI”) interferometer is proposed in U.S. Pat. No. 5,835,217. The PDI interferometer generates a reference sphere using pinholes, and can thereby measure wavefront aberration at a high degree of accuracy. As it is provided with a common optical path, the PDI interferometer has an advantage that it is hardly affected by disturbances.

However, the PDI interferometer must reduce the pinhole diameter to a size of a fraction of a diffraction limit to obtain a spherical wave of an ideal sphere and must prepare a high brightness light source as the light source. As the light source capable of meeting such requirements, only a combination of an SOR (Synchrotron Orbital Radiation) and Undulator is currently available. Since the light source combining the SOR and Undulator is very expensive and requires a large-scale apparatus, measurement of wavefront aberration using the PDI interferometer is disadvantageous in realizing it as an apparatus and in the aspect of cost, and it is therefore unrealistic.

On the other hand, one of methods for measuring wavefront aberration of a projection optical system without using any light source combining the SOR and Undulator uses a Line Diffraction Interferometer (hereinafter referred to as “LDI”) system.

However, in measurement of wavefront aberration using the LDI system, a slit equal to or smaller than an image formation limit of a projection optical system is placed at an image point, and therefore in the case of a projection optical system having large aberration, if a slit image of an object point is formed, the slit image is blurred and the quantity of light passing through the slit is reduced considerably, resulting in a problem that measurement is not possible.

FIG. 12 is a graph showing a relationship between aberration of a projection optical system and light quantity after light passes through the slit, an ideal lens of NA 0.3 is given a C9 term of the Zernike polynomial shown in Expression 1 below with varying magnitude A and the quantity of transmitted light of the slit on the image side versus the amount of aberration is plotted assuming that the intensity when aberration is 0 is 1.

C9=A(6r⁴−6R²+1) Expression 1

Referring to FIG. 12, the ratio of intensity reduces drastically from a point close to an amount of aberration of 250 mλ and the ratio of intensity falls below 20% when the amount of aberration is 500 mλ or above.

As described above, in measurement of wavefront aberration based on an LDI system using a slit, when aberration of a projection optical system is large, the quantity of light which has passed through the slit is reduced drastically, and therefore measurement of a projection optical system having large aberration is difficult.

### SUMMARY OF THE INVENTION

Therefore, it is an exemplary object of the present invention to provide an aberration measuring apparatus capable of measuring wavefront aberration at a high degree of accuracy regardless of the magnitude of aberration of an optical system.

In order to attain the above described object, an aberration measuring apparatus as an aspect of the present invention comprises a first mask which generates a wavefront including wavefront aberration of an optical system and a reference wavefront not including wavefront aberration of the optical system with respect to a predetermined direction, a second mask which generates two wavefronts both including wavefront aberration of the optical system and a detector placed at a position where the two wavefronts generated by the first mask or the two wavefronts generated by the second mask form an interference pattern. Wavefront aberration of the optical system is calculated based on the interference pattern detected by this detector. In this aberration measuring apparatus, it is possible to switch between a mode for measuring wavefront aberration of the optical system using the first mask and a mode for measuring wavefront aberration of the optical system using the second mask.

The other objects and features of the invention will become more apparent from the following detailed description of a preferred embodiment of the invention with reference to the drawings.

### BRIEF DESCRIPTION OF THE DRAWINGS

FIG. 1 is a schematic block diagram showing an exemplary mode of an aberration measuring apparatus as an aspect of the present invention;

FIG. 2 is a schematic block diagram of an aberration measuring apparatus using an LDI system;

FIG. 3 is a schematic plan view of the object side mask shown in FIG. 2;

FIG. 4 is a schematic plan view of the image side mask shown in FIG. 2;

FIG. 5 is a schematic cross sectional view of a wavefront after two diffracted light rays pass through the image side mask;

FIG. 6 is a schematic plan view showing an example of an interference pattern observed by the detector shown in FIG. 2;

FIG. 7 is a schematic plan view of the image side mask shown in FIG. 1;

FIG. 8 is a flow chart illustrating a method of adjusting a projection optical system using the aberration measuring apparatus shown in FIG. 1;

FIG. 9 is a schematic block diagram of an exemplary photolithography apparatus of the present invention;

FIG. 10 is a flow chart illustrating manufacturing of a device (semiconductor chip such as IC and LSI, LCD and CCD, etc.);

FIG. 11 is a flow chart illustrating details of step 4 shown in FIG. 10; and

FIG. 12 is a graph showing a relationship between aberration of a projection optical system and quantity of light which has passed through a slit.

### DESCRIPTION OF THE PREFERRED EMBODIMENTS

With reference now to the attached drawings, an aberration measuring apparatus which is an exemplary embodiment of the present invention will be explained below. Identical members in different figures are assigned the same reference numerals and overlapping explanations will be omitted.

The present inventor has made every effort to provide an aberration measuring apparatus capable of accurately measuring wavefront aberration regardless of the magnitude of aberration of an optical system in a back-to-basics manner and has consequently discovered the use of an LDI system when aberration of the optical system is small and a Lateral Shearing Interferometer (hereinafter referred to as “LSI”) when aberration of the optical system is large, with the LDI system as a basis.

First, using FIG. 2 to FIG. 6, measurement of wavefront aberration of a projection optical system using an LDI system will be explained. FIG. 2 is a schematic block diagram of an aberration measuring apparatus 1000 using an LDI system. In FIG. 2, suppose the horizontal direction with respect to the surface of the sheet is a z-axis and the vertical direction is a y-axis and the axis perpendicular to the y-axis and z-axis is an x-axis.

As shown in FIG. 2, the aberration measuring apparatus 1000 includes a light source 110, a condensing optical system 120, an object side mask 130 placed on the object point side of a projection optical system 530, a diffraction grating 140 which is light splitting means, an image point side mask 150 placed on the image point side of the projection optical system 530 and a detector 160 such as a back irradiation type CCD which is interference pattern observing means, and measures wavefront aberration of the projection optical system 530.

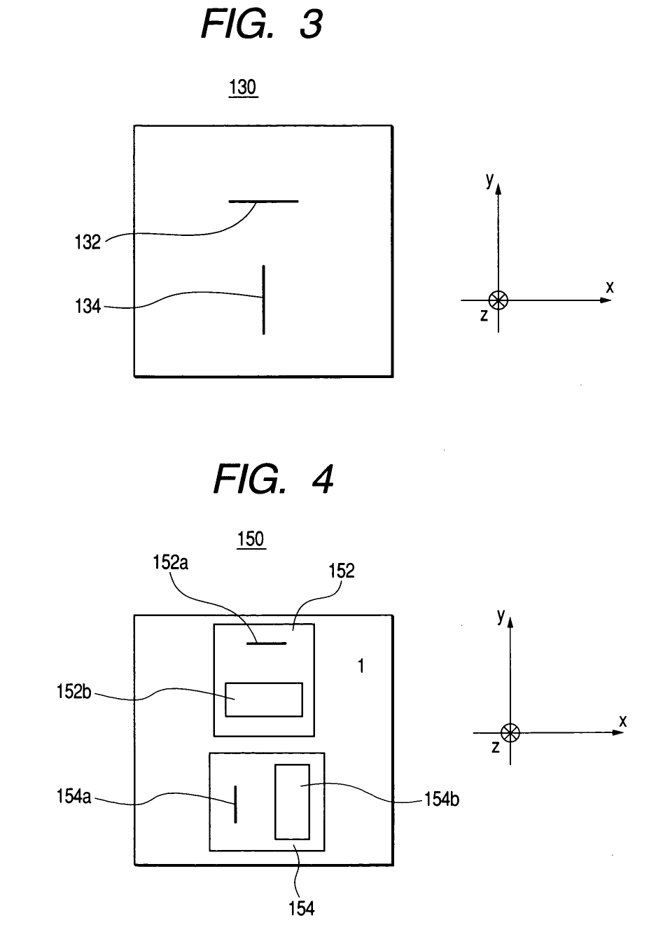

As shown in FIG. 3, the object side mask 130 is provided with slit-shaped opening patterns 132 and 134. In FIG. 3, the opening pattern 132 is oriented in the x-axis direction (direction perpendicular to the surface of the sheet) and the opening pattern 134 is oriented in the y-axis direction. Here, FIG. 3 is a schematic plan view of the object side mask 130 shown in FIG. 2.

The slot width tₒ of the opening patterns 132 and 134 has a size expressed by the following expression 2 where λ is the wavelength of the light source 110, NAₒ is the numerical aperture on the object side of the projection optical system 530.

tₒ=0.5×λ/NAₒ Expression 2

As is well known, the light emitted from the opening pattern 132 shows an intensity variation according to a sinc function, which is a stepped variation with a coherent phase near the center, showing a smooth and drastic π variation near intensity 0.

In the case of the opening pattern 132 with a slit width tₒ, the sinc function has intensity 0 at NA=λ/tₒ. Such a numerical aperture NA is double the numerical aperture NAₒ on the object side of the projection optical system 530 and the projection optical system 530 incorporates light having half or less than numerical aperture NA with which the intensity becomes 0. In such a range of numerical aperture NA, the light emitted form the opening pattern 132 can be regarded as a wavefront whose phase varies in proportion to the distance from the x-axis.

The length Lₒ of the slit of the opening patterns 132 and 134 is a length which falls within a range smaller than an isoplanar area and allows the passage of a sufficient light quantity for an observation of an interference pattern using the detector 160.

As shown in FIG. 4, the image side mask 150 has patterns of a first area 152 and a second area 154. The first area 152 consists of a slit-shaped opening pattern 152a and an opening 152b for the passage of light to be detected or analyzed. The location of second area 154 corresponds to the location of the first area 152 rotated by 90° and the second area 154 also consists of a slit-shaped opening pattern 154a and an opening 154b for the passage of light to be detected. The first area 152 is used for the light which has passed through the opening pattern 132 of the object side mask 130 and the second area 154 is used for the light which has passed through the opening pattern 134 of the object side mask 130. Here, FIG. 4 is a schematic plan view of the image side mask 150 shown in FIG. 2.

The slit width tᵢ of the opening pattern 152a of the first area 152 and the opening pattern 154a of the second area 154 has a size equal to or smaller than that expressed by the following expression 3 where λ is the wavelength of the light source 110, NAᵢ is the numerical aperture on the image side of the projection optical system 530.

Tᵢ=0.5×λ/NAᵢ Expression 3

Furthermore, the slit length Lᵢ of the opening pattern 152a of the first area 152 and the opening pattern 154a of the second area 154 is a length corresponding to the slit width tₒ of the opening pattern 132 of the object side mask 130 multiplied by power m of the projection optical system 530 as shown in Expression 4 below.

Lᵢ=m×Lₒ Expression 4

Light A emitted from the light source 110 is condensed by the condensing optical system 120 on the opening pattern 132 located on the object side mask 130. Light A emitted from the light source 110 is incoherent light, and therefore the light after passing through the opening pattern 132 becomes light with high spatial coherence in the y-axis direction perpendicular to the opening pattern 132 and light with low spatial coherence in the x-axis direction parallel to the opening pattern 132. That is, the light constitutes a spherical wave on a cross section parallel to the yz plane perpendicular to the opening pattern 132. In a narrow sense, the term “spherical wave” in this embodiment is a wave whose phase isoplane is not concentrically spherical but concentrically cylindrical. However, this concentrically cylindrical wave behaves like a spherical wave with respect to a cross section parallel to the yz plane, and therefore this embodiment refers to it as a “spherical wave with respect to a plane parallel to the yz plane”, etc. Furthermore, the “spherical wave with respect to a plane parallel to the yz plane” is a wave not including wavefront aberration of the projection optical system with respect to the y-direction. “Not including wavefront aberration” refers to a wavefront which has passed through an opening (that is, opening pattern 132) which is equal to or smaller than the diffraction limit of the projection optical system.

The light forming a spherical wave within the plane parallel to the yz plane enters the diffraction grating 140 placed between the object side mask 130 and projection optical system 530. The diffraction grating 140 consists of gratings extending in the direction parallel to the x-axis periodically arrayed along the y-axis and diffracts light in the vertical direction in FIG. 2 at angles according to grating pitch of the diffraction grating 140. Of the diffracted light rays diffracted by the diffraction grating 140, suppose the 0th-order light ray is A′ and 1st-order light ray is A″.

In FIG. 2, the diffraction grating 140 is located between the object side mask 130 and projection optical system 530, but it may also be located between the projection optical system 530 and image side mask 150.

Of the light which has been diffracted by the diffraction grating 140, passed through the projection optical system 530 and condensed, the 0th-order light ray A′ is condensed on the opening pattern 152a of the first area 152 of the image side mask 150 and the 1st-order light ray A″ is condensed on the opening 152b. Light rays of other orders are cut by a light-shielding section 156 of the image side mask 150. The diffracted light condensed on the opening 152b may also be the −1st-order light ray.

Of the two diffracted light rays which have passed through the image side mask 150, the 0th-order light ray A′ has passed through the opening pattern 152a, and therefore forms a spherical wave in the direction perpendicular to the opening pattern 152a.

The 1st-order light ray A″ passes through the opening 152b which has a sufficiently greater aperture than the diffraction limit, and is therefore not affected by wavefront modulation and forms a wavefront including aberration information on the projection optical system 530.

The two diffracted light rays (0th-order light ray A′ and 1st-order light ray A″) which have passed through the image side mask 150 form an interference pattern, which is observed by the detector 160. The detector 160 is far enough from the image side mask 150 and located in a so-called far-field area.

In the case of the interference pattern observed by the detector 160, since the 0th-order light ray A′ having a large light quantity has passed through the opening pattern 152a having a large light quantity loss and the 1st-order light ray A″ having a small light quantity has passed through the opening 152b having a low light quantity loss, the two diffracted light rays (diffracted light ray A′ and diffracted light ray A″) which have passed through the image side mask 150 have good light quantity balance and have an interference pattern with high contrast.

To further improve the contrast of the interference pattern, it is possible to change the ratio of the opening area to the light-shielding area of the diffraction grating 140 with consideration given to the loss in the light quantity at the image side mask 150 in such a way that the light quantity ratio of the 0th-order light ray A′ to the 1st-order light ray A″ which arrive at the detector 160 is 1:1.

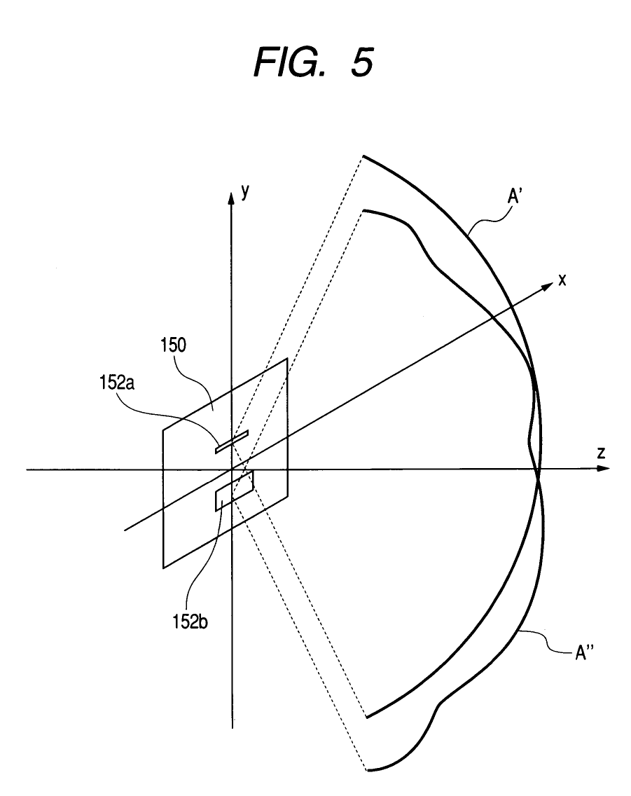

FIG. 5 is a schematic cross sectional view of a wavefront after the two diffracted light rays (0th-order light ray A′ and 1st-order light ray A″) pass through the image side mask 150. Referring to FIG. 5, since the 1st-order light ray A″ passes through the opening 152b having a sufficiently greater aperture than the diffraction limit, it propagates toward the detector 160 while carrying aberration information on the projection optical system 530. On the other hand, since the 0th-order light ray A′ passes through the opening pattern 152a having a slit width equal to or below the diffraction limit, it forms a spherical wave on a cross section parallel to the yz plane in the direction perpendicular to the opening pattern 152a and includes no aberration information on the projection optical system 530. Such a wavefront is generated along the longitudinal direction of the opening pattern 152a.

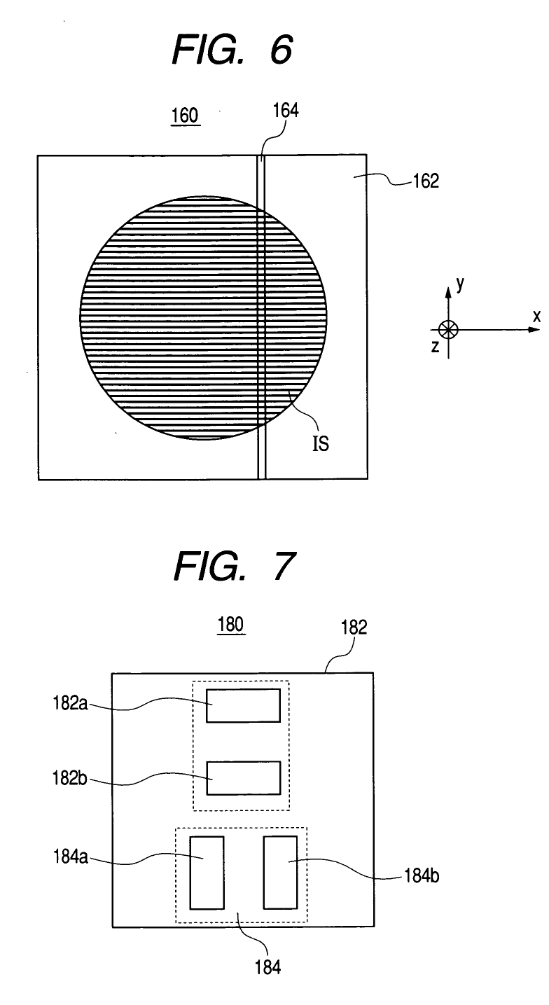

FIG. 6 is a schematic plan view showing an example of interference pattern observed by the detector 160. Referring to FIG. 6, an interference pattern IS is observed on an image-pickup plane 162 of the detector 160. Since the 0th-order light ray A′ and 1st-order light ray A″ are divided in the y-axis direction as shown in FIG. 5, the interference pattern IS is observed as a tilt pattern with horizontal stripes on the image-pickup plane 162.

With regard to the interference pattern IS observed by the detector 160, since the light which has passed through the opening pattern 152a is a spherical wave on a cross section perpendicular to the opening pattern 152a, the phase difference between the 0th-order light ray A′ and 1st-order light ray A″ is measured in the direction of the cross section perpendicular to the opening pattern 152a, that is, the phase difference is measured with an extremely high degree of absolute accuracy with respect to the y-axis direction.

For example, in FIG. 6, if the array of pixels in the y-axis direction is a pixel array 164, the interference pattern IS of the pixel array 164 is an interference pattern made up of a spherical wave with no aberration component and wavefront aberration of the projection optical system 530.

The interference pattern IS picked up by the detector 160 is sent to calculating means 170 shown in FIG. 2 and used to calculate phase information. Aberration information on the projection optical system 530 is acquired using a phase shift method. That is, by scanning the diffraction grating 140 shown in FIG. 2 in the y-axis direction, the phase of the diffracted light is shifted, and therefore it is possible to measure a phase difference between the wavefront of a spherical wave in the cross-sectional direction of the opening pattern 152a of the image side mask 150 and the wavefront of the light which has passed through the projection optical system 530 and acquired aberration information.

Or since the interference pattern IS has a TLT, it is also possible to acquire phase information using moiré interferometry. When the moiré interferometry is used, the diffraction grating 140 need not be scanned in the direction perpendicular to the optical axis.

With the interference pattern IS obtained in this way, reference light forms a spherical wave (cylindrical wave in three-dimensional terms) within the cross section parallel to the yz plane, and therefore very accurate measurement is possible.

On the other hand, in the direction along the x-axis, an LPP which is a low coherence light source is used as the light source 110, and therefore there is no phase correlation between these spherical waves. Therefore, the phase relationship in the direction along the x-axis needs to be measured.

Thus, measurements are performed in the same way as described above using the opening pattern 134 which extends in the y-axis direction of the object side mask 130 and the second area 154 of the image side mask 150. At this time, the diffraction grating 140 rotates around the z-axis so that the gratings which extend in the y-axis direction are periodically arrayed along the x-axis or is replaced with such an array of gratings.

Since the light that has passed through the opening pattern 134 of the object side mask 130, projection optical system 530 and the opening pattern 154a of the image side slit 150 forms a spherical wave (this “spherical wave” is synonymous with the aforementioned definition and means “spherical wave with respect to the cross section parallel to the xz plane” here) on the cross section parallel to the xz plane, the interference pattern observed by the detector 160 is an interference pattern of the spherical wave and the wavefront including wavefront aberration of the projection optical system 530 on the array of pixels parallel to the x-axis.

By scanning the diffraction grating 140 in the x-axis direction in such a condition, the phase of the diffracted light is shifted, and therefore it is possible to measure a phase difference between the wavefront of a spherical wave in the cross-sectional direction of the opening pattern 154a of the image side mask 150 and the wavefront of the light which has passed through the opening 154b and includes the aberration information on the projection optical system 530. Or it is also possible to acquire phase information using moiré interferometry.

Then, if the phase information in the direction along the y-axis and phase relationship in the direction along the x-axis are connected, it is possible to measure wavefront aberration on the entire surface of the pupil of the projection optical system 530 at a high degree of accuracy. The connection of the two phase relationships can be calculated using a least square method as the basis. In this way, measurement of wavefront aberration at one angle of view of the projection optical system 530 is completed.

Furthermore, it is possible to measure wavefront aberration at all angles of view of the projection optical system 530 by moving the object side mask 130 within the angle of view of the projection optical system 530, moving the image side mask 150 to the image of the object side mask 130 by the projection optical system 530, changing the condensing position of the condensing optical system 120 so as to irradiate the object side mask 130, measuring the above described phase difference and connecting the two phase relationships.

Or it is also possible to perform measurements by arranging the patterns shown in FIG. 3 and FIG. 4 at the respective angles of view to be measured of the object side mask 130 and the object side mask 150 and changing the condensing position of the condensing optical system 120.

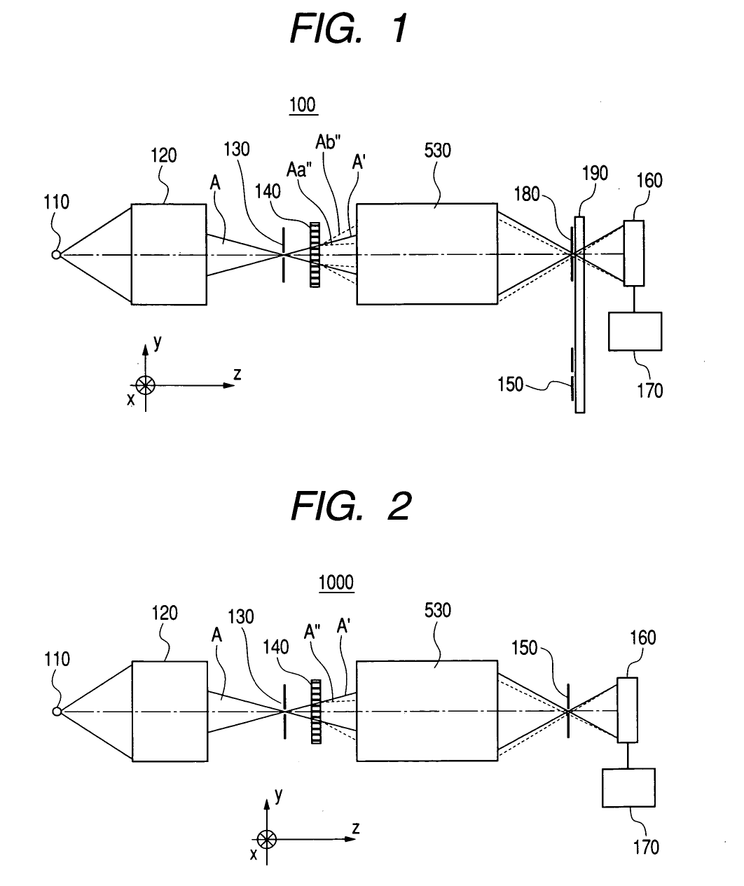

Hereafter, the aberration measuring apparatus of the present invention based on the above described LDI system will be explained. FIG. 1 is a schematic block diagram showing an exemplary mode of the aberration measuring apparatus 100 as one aspect of the present invention. When aberration of the projection optical system 530 is large, by changing the LDI system to the LSI system, the aberration measuring apparatus 100 can measure wavefront aberration of the projection optical system 530 regardless of the magnitude of aberration of the projection optical system 530.

When aberration of the projection optical system 530 is large, the aberration measuring apparatus 100 performs measurements by changing an image side mask 150 for the LDI system to an image side mask 180 for the LSI system using a mask switching means 190. The mask switching means 190 is made up of a turret, etc., and provided with the image side masks 150 and 180.

As shown in FIG. 7, the image side mask 180 consists of a first slit area 182 including a first slit 182a and a second slit 182b, and a second slit area 184 including a third slit 184a and a fourth slit area 184b. The location of the second slit area 184 corresponds to the location of the first slit area 182 rotated by 90°. Here, FIG. 7 is a schematic plan view of the image side mask 180 shown in FIG. 1.

Light A emitted from the light source 110 is condensed by the condensing optical system 120 on the opening pattern 132 located on the object side mask 130. The light A emitted from the light source 110 is incoherent light, and therefore the light after passing through the opening pattern 132 becomes light with high spatial coherence in the y-axis direction perpendicular to the opening pattern 132 and light with low spatial coherence in the x-axis direction parallel to the opening pattern 132. That is, the light constitutes a spherical wave on a cross section parallel to the yz plane perpendicular to the opening pattern 132.

The light forming a spherical wave within the plane parallel to the yz plane enters the diffraction grating 140 placed between the object side mask 130 and projection optical system 530. The diffraction grating 140 consists of gratings extending in the direction parallel to the x-axis periodically arrayed along the y-axis and diffracts light in the vertical direction in the figure, in other words, by dividing the light in the y-axis direction at angles according to grating pitch of the diffraction grating 140. Of the diffracted light rays diffracted by the diffraction grating 140, suppose the 0th-order light ray is A′, 1st-order light ray is Aa″ and −1st-order light ray is Ab″.

In FIG. 1, the diffraction grating 140 is located between the object side mask 130 and projection optical system 530, but it may also be located between the projection optical system 530 and image side mask 180.

The light which has been diffracted by the diffraction grating 140 and passed through the projection optical system 530 is condensed on the image side mask 180. Of the condensed light, the −1st-order light ray Ab″ is condensed on the first slit 182a of the image side mask 180 and the 1st-order light ray Aa″ is condensed on the second slit 182b. The 0th-order light ray A′ is cut by a light-shielding section between the first slit 182a and the second slit 182b. Light rays of other orders are also cut by the light-shielding section of the image side mask 180.

The 1st-order light ray Aa″ and the −1st-order light ray Ab″ pass through the first slit area 182 having a sufficiently greater aperture than the diffraction limit, and therefore it is a wavefront including aberration information on the projection optical system 530.

The two diffracted light rays (1st-order light ray Aa″ and −1st-order light ray Ab″) which have passed through the image side mask 180 form an interference pattern, which is observed by the detector 160. The detector 160 is far enough from the image side mask 180 and located in a so-called far-field area.

The interference pattern picked up by the detector 160 is sent to the calculation means 170 and used for a calculation of phase information. A phase shift method is used to acquire phase information on the projection optical system 530 from the interference pattern. That is, by scanning the diffraction grating 140 shown in FIG. 1 in the y-axis direction, the phase of the diffracted light is shifted and therefore it is possible to calculate a phase difference between the 1st-order light ray Aa″ and −1st-order light ray Ab″.

Or since the interference pattern has a TLT, it is also possible to acquire phase information using moire interferometry. When the moire interferometry is used, the diffraction grating 140 need not be scanned in the direction perpendicular to the optical axis.

The light which has passed through the image side mask 180 corresponds to two wavefronts including aberration information on the projection optical system 530 shifted in the y-direction and superimposed, and therefore the phase information calculated by the calculating means 170 is a difference value of the wavefront aberration of the projection optical system 530. The difference value of the wavefront aberration can be regarded as a differential value when the shear amount is sufficiently small. That is, at coordinates (X, Y) on the pupil of the projection optical system 530, phase information P satisfies following expression 5 where W is wavefront aberration at pupil coordinates (X, Y) of the projection optical system 530 and s is an amount of shift between the two wavefronts.

P=(W(X, Y+s)−W(X, Y))=s×dW(X, Y)/dY Expression 5

To calculate wavefront aberration W of the projection optical system 530, the differential value in the x-direction is also necessary in addition to the differential value in the y-direction of the wavefront obtained from expression 5.

Therefore., measurements will be performed in the same way as that described above using the opening pattern 134 extending in the y-direction of the object side mask 130 and the second slit area 184 of the image side mask 180 in FIG. 7. At this time, the diffraction grating 140 rotates around the z-axis in such a way that the gratings extending in the y-direction are arrayed periodically along the x-axis or is replaced with such an array of gratings.

BY scanning the diffraction grating 140 in such a condition, the phase of the diffracted light is shifted, and therefore it is possible to measure phase information dW/dX of an interference pattern of the 1st-order light ray Aa″ and −1st-order light ray Ab″. Or it is also possible to acquire phase information using moire interferometry.

Then, based on the differential value of the two wavefronts obtained, it is possible to calculate wavefront aberration of the projection optical system 530 by the calculating means 170 and measure wavefront aberration W of the projection optical system 530. It is possible to use a least square method to calculate wavefront aberration from the differential value of wavefronts in the two directions; x-direction and y-direction.

Furthermore, the object side mask 130 is moved within the angle of field of the projection optical system 530, the image side mask 180 is moved to the image of the object side mask 130 by the projection optical system 530, the condensing position of the condensing optical system 120 is changed to an angle of view to be measured, the above described measurement and wavefront aberration are calculated, and it is thereby possible to acquire wavefront aberration at all angles of view of the projection optical system 530.

Or it is also possible to acquire aberration information at all angles of view of the projection optical system 530 using the masks on which the pattern shown in FIG. 3 is arranged at all angles of view to be measured and the mask on which the pattern shown in FIG. 7 is arranged at all angles of view and by condensing light at the angle of view to be measured by the condensing optical system 120.

This embodiment has used the ±1st-order light rays, but it is also possible to use the 0th-order light ray and 1st-order light ray. In this case, it is preferable to balance light quantities by narrowing the opening of the diffraction grating 140 with respect to the light-shielding section.

Measurement of aberration using an LSI system arranges a slit sufficiently greater than the diffraction limit at the image point and uses no narrow slit, and therefore measurement of wavefront aberration is possible even when aberration of the optical system to be detected is large.

That is, the aberration measuring apparatus 100 can measure two types of wavefront aberration of the LSI system and LDI system by comprising the mask switching means 190 capable of switching between the LDI image side mask 150 and LSI image side mask 180 and the calculating means 170 having a wavefront aberration calculation function according to the LDI system and LSI system.

Therefore, in the initial stage of assembly and adjustment of the projection optical system with large aberration, wavefront aberration is measured using the image side mask 180 according to the LSI system, and when the projection optical system is ready to measure wavefront aberration according to the LDI system after the adjustment, the image side mask 180 is changed to the image side mask 150 and wavefront aberration is measured according to the LDI system, and in this way it is possible for one apparatus to measure wavefront aberration of a projection optical system irrespective of the magnitude of aberration and thereby improve the performance of the projection optical system.

Since the LDI system directly measures a wavefront, it has a higher degree of measurement accuracy than the LSI system which measures a differential value of a wavefront. Thus, the aberration measuring apparatus 100 can adjust the projection optical system to lower aberration by performing the last part of adjustment according to the LDI system.

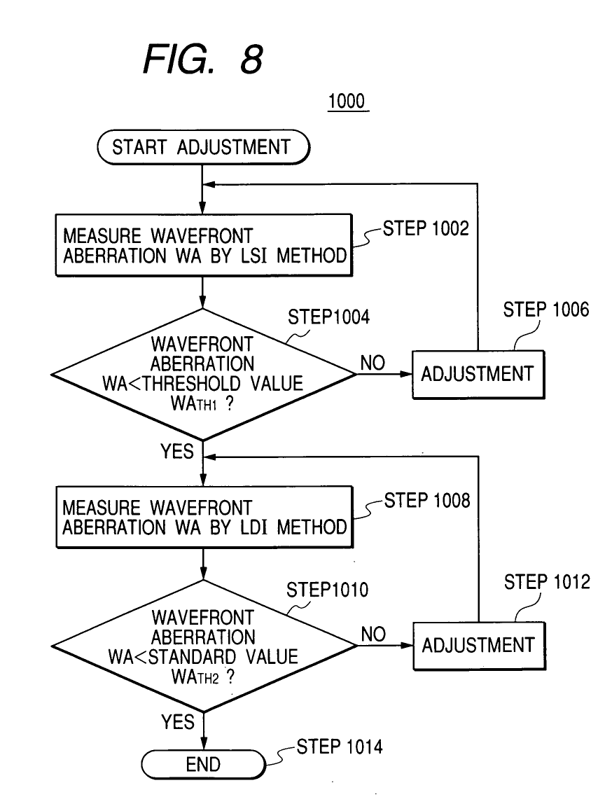

Hereinafter, the method of adjusting the projection optical system using the aberration measuring apparatus 100 will be explained with reference to FIG. 8. FIG. 8 is a flow chart illustrating a method of adjusting a projection optical system 1000 using the aberration measuring apparatus 100.

First, wavefront aberration WA of a projection optical system will be measured according to the LSI system using the image side mask 180 (step 1002). Then, it is decided whether the measured wavefront aberration WA of the projection optical system is equal to or lower than an amount of wavefront aberration (threshold value) WATH1 which can be measured according to the LDI system or not (step 1004). When the measured wavefront aberration WA of the projection optical system is decided to be equal to or higher than the amount of wavefront aberration (threshold value) WATH1, the optical members of the projection optical system are subjected to adjustments of eccentricity, rotation, change of intervals, re-polishing of form, reflective multilayer film phase adjustment, etc., (step 1006) and steps from step 1002 onward will be repeated. When the measured wavefront aberration WA of the projection optical system is decided to be lower than the amount of wavefront aberration (threshold value) WATH1, the mask switching means 190 changes the image side mask 180 to the image side mask 150 and wavefront aberration WF of the projection optical system will be measured according to the LDI system (step 1008). Then, it is decided whether the measured wavefront aberration WF of the projection optical system is equal to or lower than an amount of wavefront aberration WATH2 of the projection optical system or not (step 1010). When the measured wavefront aberration WF of the projection optical system is decided to be equal to or higher than the amount of wavefront aberration WATH2, the optical members of the projection optical system are subjected to adjustments of eccentricity, rotation, change of intervals, re-polishing of form, reflective multilayer film phase adjustment, etc., (step 1012) and steps from step 1008 onward will be repeated. When the measured wavefront aberration WA of the projection optical system is decided to be lower than the amount of wavefront aberration WATH2, the adjustment of the projection optical system is completed (step 1014).

Therefore, according to the adjustment method 1000, it is possible to combine the LSI system and LDI system and carry out the last part of the adjustment according to the LDI system and thereby adjust the projection optical system to lower aberration.

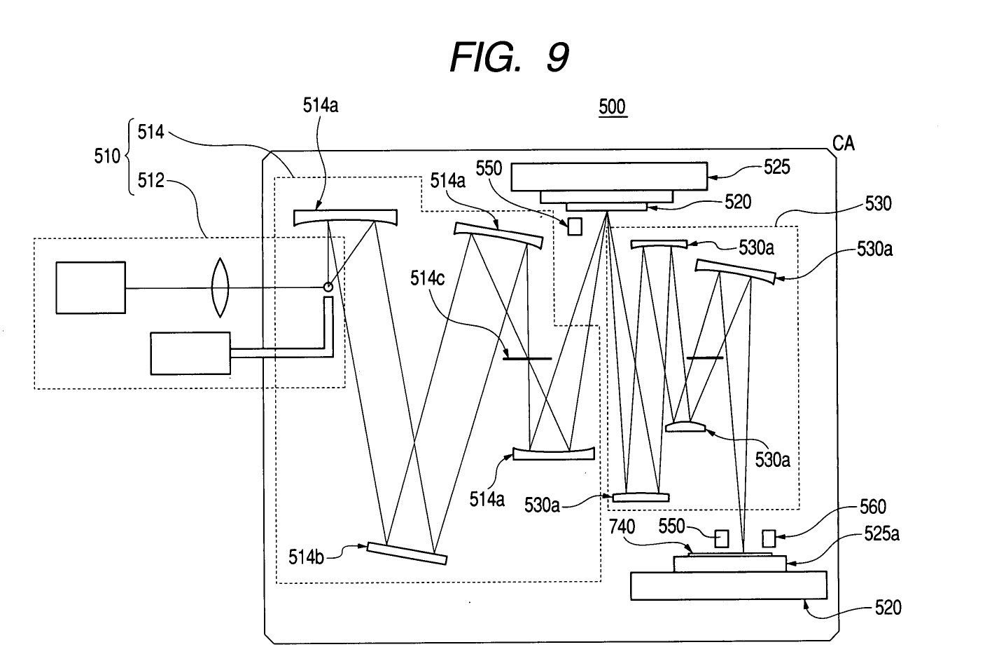

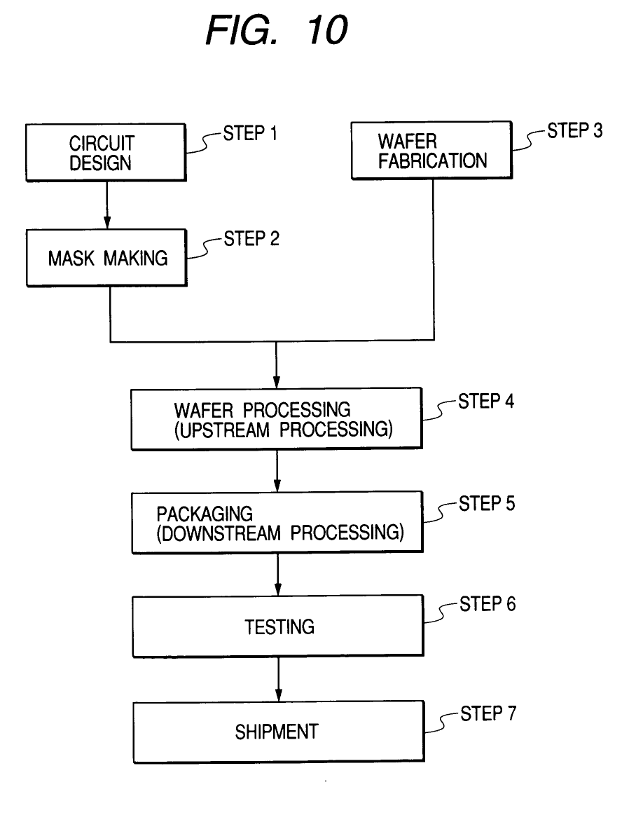

With reference to FIG. 9, an exemplary photolithography apparatus 500 of the present invention will be explained. Here, FIG. 9 is a schematic block diagram of the exemplary photolithography apparatus 500 of the present invention.

The photolithography apparatus 500 of the present invention is a projection photolithography apparatus which projects a circuit pattern formed on a reticule 520 according to, for example, a step and scan system or step and repeat system onto an object to be processed 540 through exposure to light using EUV light (e.g., wavelength of 13.4 nm) as illumination light for exposure. Such a photolithography apparatus is preferably used for a lithography step on the order of submicrons or quarter micron or less and this embodiment will explain a photolithography apparatus (also called “scanner”) according to a step and scan system as an example. Here, the “step and scan system” is an exposure method which projects a mask pattern onto a wafer by continuously scanning the wafer to the mask through exposure to light, moves the wafer after completion of one-shot exposure on a step-by-step basis and moves to the next exposure area. The “step and repeat system” is an exposure method which moves the wafer on a step-by-step basis every time batch exposure is applied to the wafer and moves to the next exposure area.

Referring to FIG. 9, the photolithography apparatus 500 is provided with an illumination apparatus 510, a reticule 520, a reticule stage 525 on which the reticule 520 is placed, a projection optical system 530, an object to be processed 540, a wafer stage 545 on which the object to be processed 540 is placed, an alignment detection mechanism 550 and a focus position detection mechanism 560.

Furthermore, as shown in FIG. 9, EUV light has low transmittance with respect to the atmosphere and generates contamination due to a reaction with residual gas (oxygen, carbon dioxide, vapor, etc.) components, and therefore the interior of the optical path through which EUV light passes (that is, entire optical system) is kept to a vacuum atmosphere VC.

The illumination apparatus 510 is an illumination apparatus which illuminates the reticule 520 with arc-shaped EUV light (e.g., wavelength of 13.4 nm) for an arc-shaped field of view of the projection optical system 530 and provided with an EUV light source 512 and an illumination optical system 514.

For the EUV light source 512, for example, a laser plasma light source is used. The laser plasma light source irradiates a target material in a vacuum recipient with high-intensity pulse laser light, generates high temperature plasma and uses EUV light having a wavelength of approximately 13 nm emitted therefrom. As the target material, a metal film, gas jet, liquid droplet, etc., is used. In order to increase average intensity of emitted EUV light, the repetition frequency of the pulse laser is preferably high and the pulse laser is normally operated at a repetition frequency of several kHz.

The illumination optical system 512 is constructed of a condensing mirror 512a and an optical integrator 512b. The condensing mirror 512a plays a role of gathering EUV light emitted isotropically from the laser plasma. The optical integrator 512b has a role of uniformly illuminating the reticule 520 with predetermined numerical aperture. Furthermore, the illumination optical system 512 is provided with an aperture 512c for limiting the illumination area of the reticule 520 to an arc shape in a position conjugate with the reticule 520.

The reticule 520 is a reflective mask, on which a circuit pattern (or image) to be transferred is formed and supported on the mask stage and driven. The diffracted light emitted from the reticule 520 is reflected by the projection optical system 530 and projected onto the object to be processed 540. The reticule 520 and the object to be processed 540 are placed in an optically conjugate relationship. Since the photolithography apparatus 500 is a photolithography apparatus according to a step and scan system, it scans the reticule 520 and the object to be processed 540 and thereby compresses and projects the pattern of the reticule 520 onto the object to be processed 540.

The reticule stage 525 supports the reticule 520 and is connected to a moving mechanism (not shown). Any publicly known structure in the industry is applicable to the reticule stage 525. The moving mechanism (not shown) is constructed of a linear motor, etc., and can move the reticule 520 by driving the reticule stage 525 at least in the X-direction. The photolithography apparatus 500 scans with the reticule 520 synchronized with the object to be processed 540. Here, suppose the scanning direction is X within the plane of the reticule 520 or the object to be processed 540, the direction perpendicular thereto is Y and the direction perpendicular to the plane of the reticule 520 or the object to be processed 540 is Z.

The projection optical system 530 reduces a pattern on the reticule 520 and projects it onto the object to be processed 540 which is the image plane using a plurality of reflective mirrors (that is, multilayer film mirror) 530a. The number of the plurality of mirrors 530a is about 4 to 6. To realize a wide exposure area with a small number of mirrors, the reticule 520 and object to be processed 540 are scanned simultaneously using only a thin arc-shaped area (ring field) at a predetermined distance from the optical axis to transfer a wide area thereof. The numerical aperture (NA) of the projection optical system 530 is approximately 0.1 to 0.2. The aberration measuring apparatus 100 and the adjustment method 1000 using the aberration measuring apparatus 100 of the present invention are applied to such a projection optical system 530, which has aberration equal to or lower than a standard value of the projection optical system 530 and can display excellent image formation performance.

The object to be processed 540 according to this embodiment is a wafer, but it includes a wide range of liquid crystal substrates and other objects to be processed. A photoresist is applied to the object to be processed 540. The photoresist application step includes preprocessing, processing for applying a contact improving agent, photoresist application processing and prebake processing. The preprocessing includes cleaning, drying, etc. The processing for applying a contact improving agent is processing of surface reforming (that is, hydrophobic transformation through application of a surface-active agent) to increase adherence between the photoresist and base, and applies coating or vapor processing with an organic film such as HMDS (Hexamethyl-disilazane), etc. Prebake is a baking step, but it is softer than that after development and removes a solvent.

The wafer stage 545 supports the object to be processed 545 through a wafer chuck 545a. The wafer stage 545 moves the object to be processed 540 in the XYZ direction using, for example, a linear motor. The reticule 520 and the object to be processed 540 are scanned synchronously. Furthermore, the position of the reticule stage 525 and the position of the wafer stage 545 are monitored by, for example, a laser interferometer and both are driven at a fixed speed ratio.

The alignment detection mechanism 550 measures the positional relationship between the reticule 520 and the optical axis of the projection optical system 530 and the positional relationship between the object to be processed 540 and the optical axis of the projection optical system 530 and sets the positions and angles of the reticule stage 525 and wafer stage 545 so that the projected image of the reticule 520 matches a predetermined position of the object to be processed 540.

The focus position detection mechanism 560 measures the focus position in the Z-direction on the surface of the object to be processed 540, controls the position and angle of the wafer stage 545 and thereby always keeps the plane of the object to be processed 540 at the position of image formation by the projection optical system 530.

During exposure to light, the EUV light emitted from the illumination apparatus 510 illuminates the reticule 520 and forms an image of the pattern on the surface of the reticule 520 on the surface of the object to be processed 540. In this embodiment, the image plane becomes an arc-shaped (ring-shaped) image plane and the total surface of the reticule 520 is exposed to light by scanning the reticule 520 and the object to be processed 540 at a speed ratio of the reduction ratio.

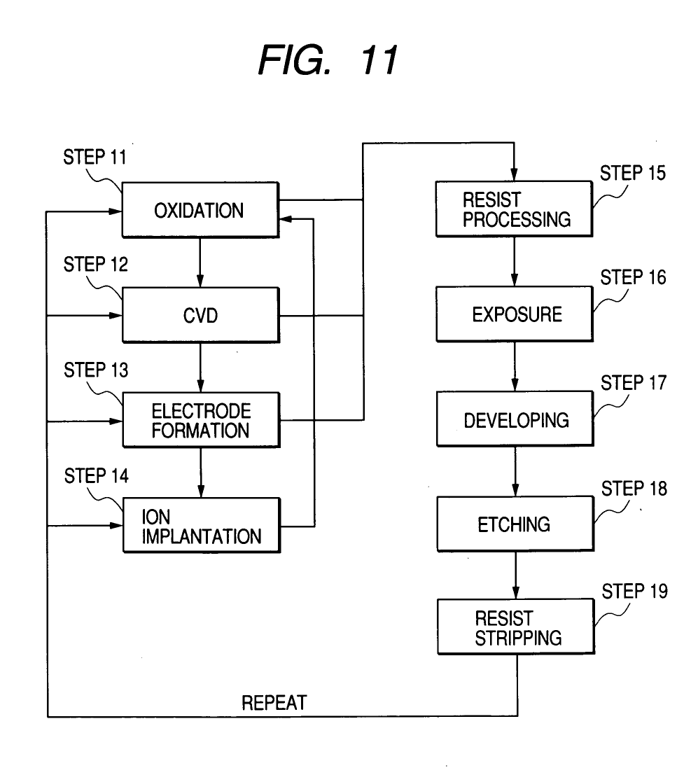

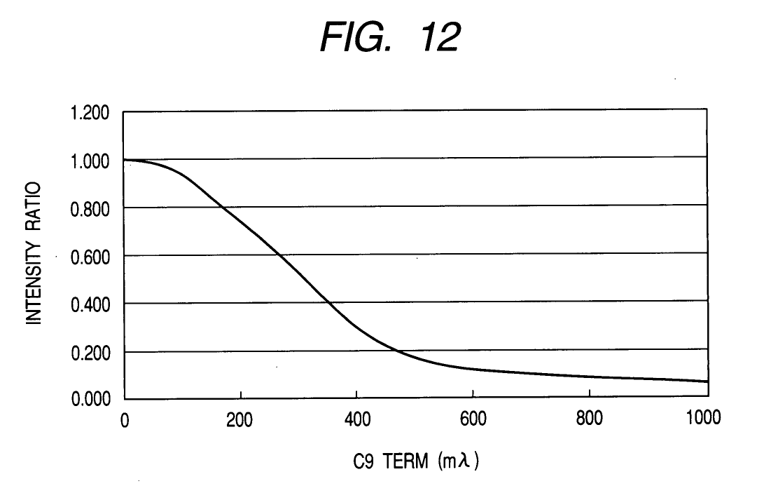

Then, with reference to FIG. 10 and FIG. 11, an embodiment of the device manufacturing method using the above described photolithography apparatus 500 will be explained. FIG. 10 is a flow chart illustrating manufacturing of a device (semiconductor chip such as IC and LSI, LCD and CCD, etc.). In this embodiment, manufacturing of a semiconductor chip will be explained as an example. In step 1 (circuit design), circuit design of the device will be conducted. In step 2 (mask making), a mask on which a designed circuit pattern is formed will be created. In step 3 (wafer fabrication), a wafer will be created using a material such as silicon. In step 4 (wafer processing) which is called “upstream processing”, an actual circuit will be formed on the wafer using the mask and wafer according to a lithography technology. Step 5 (packaging) is called “downstream processing” and is a step of creating a semiconductor chip using the wafer created in step 4 and it includes an assembly step (dicing and bonding), packaging step (chip inclusion), etc. In step 6 (testing), testing such as an operation check test and durability test, etc., are conducted on the semiconductor device created in step 5. Through these steps, a semiconductor device is completed and shipped (step 7).

FIG. 11 is a detailed flow chart of the wafer processing in step 4. In step 11 (oxidation), the surface of the wafer is oxidized. In step 12 (CVD), an insulating film is formed on the surface of the wafer. In step 14 (ion implantation), ions are implanted in the wafer. In step 15 (resist processing), a photosensitizer is applied to the wafer. In step 16 (exposure), a mask circuit pattern is projected onto the wafer through exposure to light using the photolithography apparatus 500. In step 17 (developing), the wafer exposed to light is developed. In step 18 (etching), parts other than the developed resist image are erased. In step 19 (resist stripping), the resist which becomes unnecessary after etching is removed. Repeating these steps, multiple layers of circuit patterns are formed on the wafer. According to the device manufacturing method in this embodiment, it is possible to manufacture a higher definition devices than in the conventional art. Thus, the device manufacturing method using the photolithography apparatus 500 and the resultant device also constitute one aspect of the present invention.

The preferred embodiments of the present invention have been explained so far, but it goes without saying that the present invention is not limited to these embodiments and can be modified and changed in various ways within the range of the essence thereof.

What is claimed is:

1. An aberration measuring apparatus comprising:
a first mask which generates a wavefront including wavefront aberration of an optical system and a reference wavefront not including wavefront aberration of said optical system with respect to a predetermined direction from light passing through said optical system;
a second mask which generates two wavefronts, both of which include wavefront aberration of said optical system from the light passing through said optical system; and
a detector placed at a position where the two wavefronts generated by said first mask or the two wavefronts generated by said second mask form an interference pattern,
wherein wavefront aberration of said optical system is calculated based on the interference pattern detected by said detector, and
said aberration measuring apparatus can switch between a mode for measuring wavefront aberration of said optical system using said first mask and a mode for measuring wavefront aberration of said optical system using said second mask.

2. The aberration measuring apparatus according to claim 1, wherein said first mask is provided with an opening equal to or greater in size than a diffraction limit of said optical system and an opening smaller in size than a diffraction limit of said optical system with respect to said predetermined direction.

3. The aberration measuring apparatus according to claim 1, wherein said second mask is provided with two openings which is greater in size than the diffraction limit of said optical system.

4. An adjusting method for reducing wavefront aberration of an optical system comprising:
a first measuring step of measuring wavefront aberration of said optical system using a Lateral Shearing Interferometer system;
a step of deciding whether wavefront aberration of said optical system measured in said first measuring step is equal to or lower than a predetermined value or not;
a second measuring step of measuring wavefront aberration of said optical system using a Line Diffraction Interferometer system when it is decided in said deciding step that wavefront aberration of said optical system measured in said first measuring step is below a predetermined value; and
a step of adjusting said optical system so that wavefront aberration measured in said second measuring step falls below a standard value.

5. The adjusting method according to claim 4, further comprising a step of adjusting said optical system so that wavefront aberration falls below said predetermined value when it is decided that wavefront aberration of said optical system measured in said first measuring step is equal to or greater than said predetermined value.

6. A photolithography apparatus comprising:
a first stage on which a reticule in which a pattern is formed is mounted;
a second stage on which an object to be processed is mounted; and
a projection optical system which projects a pattern formed on said reticule onto said object to be processed,
wherein wavefront aberration of said projection optical system is measured using the aberration measuring apparatus according to claim 1.

7. A device manufacturing method comprising:
a step of applying a photosensitizer to an object to be processed;
an exposing step of exposing said object to be processed by the photolithography apparatus according to claim 6; and
a developing step of developing said exposed object to be processed.

8. A photolithography apparatus comprising:
a first stage on which a reticule in which a patter is formed is mounted;
a second stage on which an object to be processed is mounted; and
a projection optical system which projects a pattern formed on said reticule onto said object to be processed,
wherein said projection optical system is adjusted using the adjusting method according to claim 4.

9. A device manufacturing method comprising:
a step of applying a photosensitizer to an object to be processed;
an exposing step of exposing said object to be processed using the photolithography apparatus according to claim 8; and
a developing step of developing said exposed object to be processed.
